(19) United States
(12) Patent Application Publication
(10) Pub. No.: US 2024/0246004 A1
(43) Pub. Date: Jul. 25, 2024

(54) PHOTOLUMINESCENT FLYING DISC CHARGING DEVICE AND SYSTEM

(71) Applicant: Benjamin Andrew Hofstede, Brampton (CA)

(72) Inventor: Benjamin Andrew Hofstede, Brampton (CA)

(21) Appl. No.: 18/098,784

(22) Filed: Jan. 19, 2023

(51) Int. Cl. A63H 33/18; A63B 65/10; A63H 33/22

(52) U.S. Cl. CPC A63H 33/18; A63B 65/10; A63H 33/22; C09K 11/00

(57) ABSTRACT

A device for charging photoluminescent objects is disclosed herein. The device is particularly used for charging phosphorescent, or ‘glow-in-the-dark’ flying discs. In some embodiments, the device includes a body having a disc-like shape with a generally planar profile; a light source disposed within the body and configured to emit a light able to be absorbed by phosphors in the photoluminescent flying discs; and a power supply port configured to connect the light source with an external power supply. In some embodiments, the external power supply is a portable battery. The device is preferably able to charge two photoluminescent flying discs simultaneously.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of projectile game accessories of existing art and more specifically relates to a portable light device for charging photoluminescent objects, particularly photoluminescent flying discs.

### RELATED ART

Phosphorescence, the phenomenon that you see when something glows in the dark, occurs when a material absorbs energy from a light source, and continues to emit light after the light source has been removed. Many objects have been developed that are made from these photoluminescent materials. For example, novelty items, sport accessories, traffic safety signs, etc. Particularly, photoluminescent materials are used in many accessories for sports that are beneficial to be played outside but are unable to be played in the dark.

One such example is disc golf. Disc golf is a sport in which players throw a ‘flying disc’ at a target. Many flying discs for playing disc golf have been developed using glow-in-the-dark plastic. These flying discs, like any photoluminescent object, need to be ‘charged’ after a certain amount of time in order to maintain or restore the glow. To charge the flying discs, they must be placed in contact with a light source for them to absorb the energy from the light source. As such, it would be beneficial to provide a device that easily charges flying discs and is able to do so during storage or transportation thereof.

### SUMMARY OF THE INVENTION

In view of the foregoing disadvantages inherent in the known projectile game accessories art, the present disclosure provides a novel photoluminescent flying disc charging device and system. The general purpose of the present disclosure, which will be described subsequently in greater detail, is to provide a portable light that is used to charge (energize) photoluminescent objects via light energy absorption. Particularly, the portable light may charge photoluminescent flying discs.

A device for charging photoluminescent objects is disclosed herein. The device may include a body, a light source and a power supply port. Further, in some embodiments, the device may include an external power supply. The body may include a first side opposite a second side. The light source may be disposed within the body and configured to emit a light able to be absorbed by phosphors in the photoluminescent objects. The light may be emitted at both the first side and the second side of the body (when the light source is on). As such, the light source may be able to charge at least two photoluminescent objects simultaneously when the body is inserted therebetween. The power supply port may be disposed in the body and configured to connect the light source with the external power supply.

According to another embodiment, a photoluminescent flying disc system is also disclosed herein. The photoluminescent flying disc system may include the device for charging the plurality of luminescent flying discs as discussed above; and a plurality of photoluminescent flying discs. The device may further include the body having a disc-like shape with the first side and the second being generally flat.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a photoluminescent flying disc charging device and system, constructed and operative according to the teachings of the present disclosure.

FIG. 1 is a front perspective view of a device for charging photoluminescent flying discs, the device including a body, a light source, a power supply port and an external power supply, according to an embodiment of the disclosure.

FIG. 2 is a front view of a printed circuit board having a plurality of light emitting diodes mounted thereon, according to an embodiment of the present disclosure.

FIG. 3 is a front view of the device having a plurality of light apertures for receiving the plurality of light emitting diodes, according to an embodiment of the present disclosure.

FIG. 4 is a side view of the device, according to an embodiment of the present disclosure.

FIG. 5 is a side perspective view of the device being placed in between two photoluminescent flying discs, according to an embodiment of the present disclosure.

FIG. 6 is a side view of the device in between two photoluminescent flying discs, according to an embodiment of the present disclosure.

FIG. 7 is a front view of the device having a plurality of LED strips, according to another embodiment of the present disclosure.

FIG. 8 is a front perspective view of the device of FIG. 7, according to an embodiment of the present disclosure.

FIG. 9 is a perspective view of a photoluminescent flying disc system including the device of FIG. 1, a plurality of photoluminescent flying discs and a receptacle, according to an embodiment of the present disclosure.

FIG. 10 is a perspective view of a photoluminescent flying disc system including the device of FIG. 7, the plurality of photoluminescent flying discs and the receptacle, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to projectile game accessories and more particularly to a photoluminescent flying disc charging device and system. Generally, the present disclosure teaches a device configured to emit light. In doing so, the device may charge (energize) photoluminescent objects via light energy absorption. Particularly, the device may be used to charge phosphorescent, or ‘glow-in-the-dark’, frisbees/flying discs. In some embodiments, the device may include a plurality of light emitting diodes (LEDs) configured to emit light from both sides of the device.

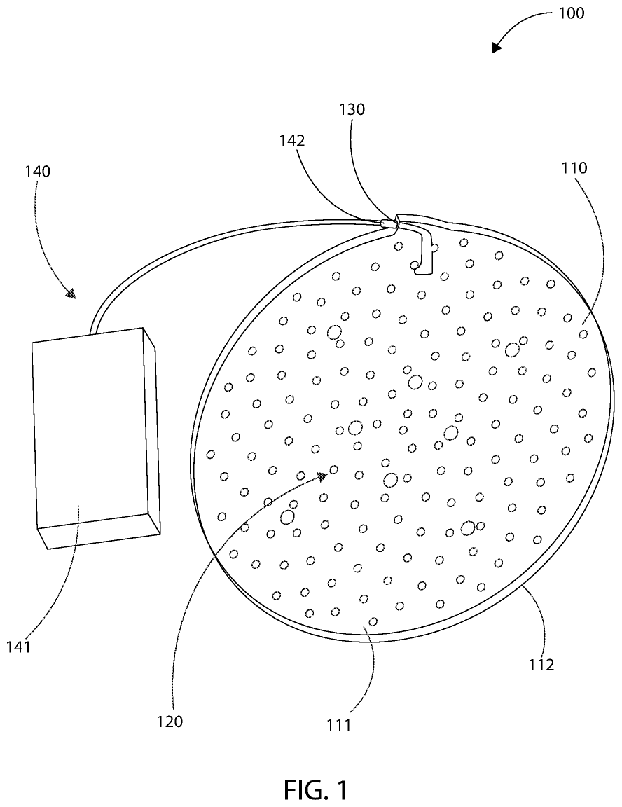

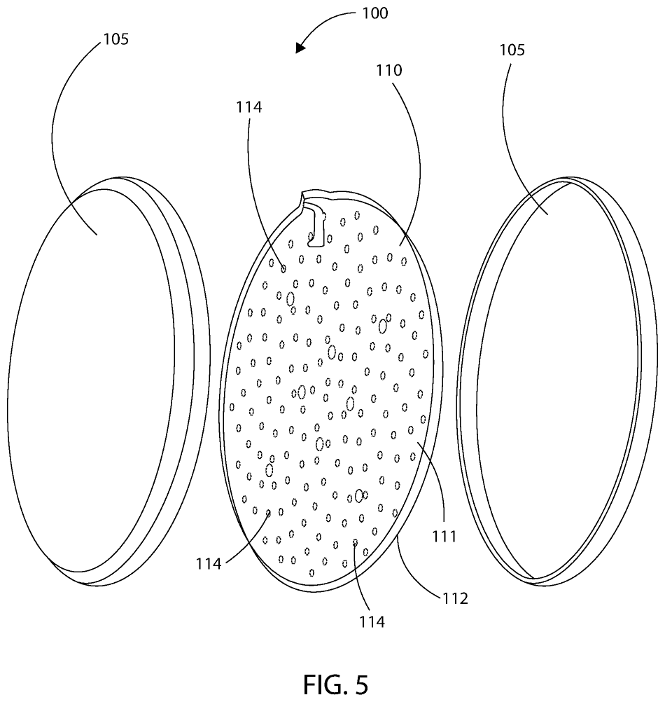

Referring now more specifically to the drawings by numerals of reference, there is shown in FIGS. 1-10, various views of a device 100 for charging photoluminescent objects. As shown in these figures the device 100 may include a body 110, a light source 120 and a power supply port 130. Preferably, as above, the device 100 may be used for charging photoluminescent flying discs 105 (FIGS. 5-6 and FIGS. 9-10).

In some embodiments, as particularly shown in FIG. 1, the device 100 may further comprise an external power supply 140, and as shown, the power supply port 130 may be configured to connect the external power supply 140 to the light source 120. Preferably, the external power supply 140 may include a portable battery 141. This may enable the device 100 to be used during travel. It should be appreciated however that the device 100 is not limited to use with the portable battery 141, and it is contemplated that other power sources may supply power to the device 100.

Further, in some embodiments, the device 100 may include a battery disposed in the body 110 (not illustrated). For example, the external power supply 140 may include an internal battery. In some examples, the internal battery may be a rechargeable battery, such as a lithium-ion battery. In other examples, the internal battery may be a disposable (and removable) battery such as an alkaline battery. It should however be appreciated that the external power supply 140 is not limited to these examples.

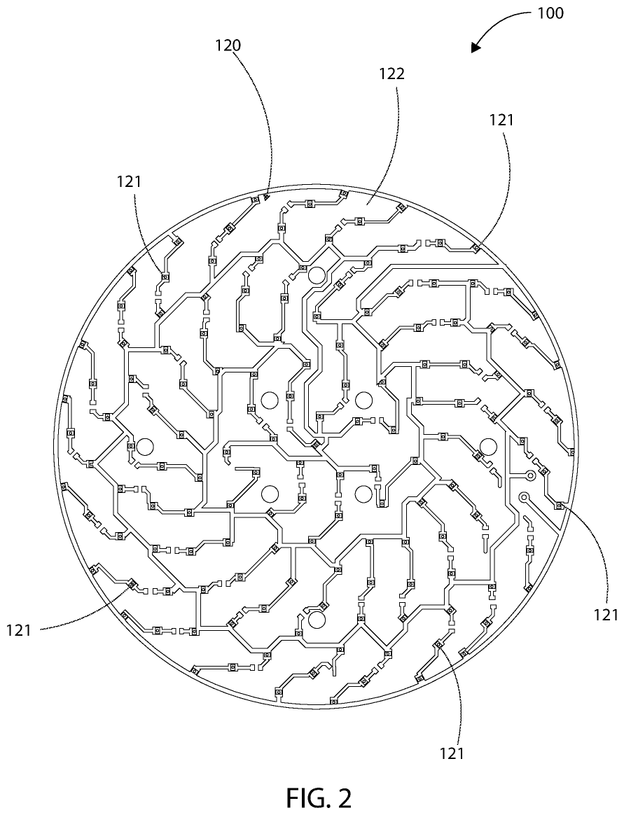

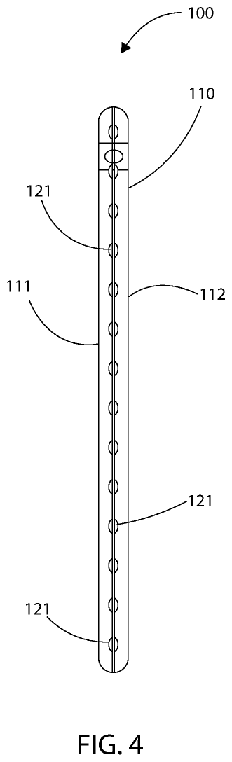

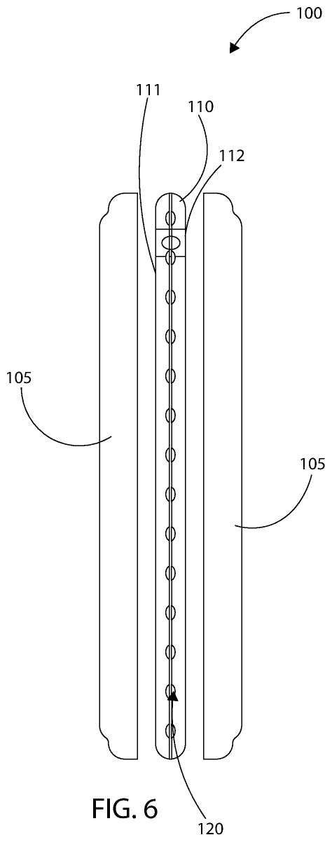

FIGS. 2-8 particularly illustrate the body 110 and the light source 120. As shown, the body 110 may include a first side 111 (e.g., a front side) opposite a second side 112 (e.g., a rear side). As shown particularly in FIG. 4 and FIG. 6, the first side 111 and the second side 112 may be generally flat, enabling the photoluminescent objects to closely abut the first or second side 111, 112 for improved light absorption. Further, the body 110 may be made from strong durable materials such as (but not limited to) plastic to resist damage associated with travel. In some embodiments, the body 110 may be constructed of two halves. For example, the first side 111 and the second side 112 of the body 110 may be fastened together to assemble the body 110.

The device 100 may include a shape and size substantially equal to that of the photoluminescent objects. For example, as above, the device 100 may be used for charging photoluminescent flying discs 105 (FIGS. 5-6). As such, the body 110 may include a disc-like shape generally equal to the photoluminescent flying discs 105. For example, a diameter of the body 110 may be equal to, or slightly larger than the photoluminescent flying discs 105, so as to ensure that an entirety of the photoluminescent flying discs 105 are charged by the light source 120. For example, the body 110 may include (but is not limited to) a diameter of between 21-30 cm. It should however be appreciated that the device 110 may be used to charge objects other than photoluminescent flying discs 105, and as such, other shapes and sizes of the body 110 may be contemplated.

The light source 120 may be disposed within the body 110 and configured to emit a light able to be absorbed by phosphors integral to the photoluminescent objects. For example, the light source 120 may be configured to emit ultraviolet (UV) light. However, it should be appreciated that other light means may be contemplated. For example, the light source 120 may emit fluorescent light, incandescent light, etc. The light may be emitted at both the first side 111 and the second side 112 of the body 110 (when the light source 120 is on). For example, the light source 120 may be disposed within an interior of the body 110 and the light source 120 may be visible from both the first side 111 and the second side 112 of the body 110. Particularly, in this embodiment, the light source 120 may inserted between the first side 111 and the second side 112 of the body 110.

As shown in FIG. 2 particularly, the light source 120 may include a plurality of light emitting diodes 121. The plurality of light emitting diodes 121 may be mounted to a printed circuit board 122 that is in turn electrically connected to the power supply port 130 and thereby able to receive power from the external power supply 140 (FIG. 1). As shown in FIG. 2, the printed circuit board 122 may include the disc-like shape, matching the shape of the body 110. The printed circuit board 122 may be enclosed between the two halves, or two sides 111, 112 of the body 110. Further, the plurality of light emitting diodes 121 may be arranged in a pattern to match the photoluminescent object, or more particularly, the photoluminescent flying disc 105. For example, the plurality of light emitting diodes 121 may be arranged in a sunflower pattern.

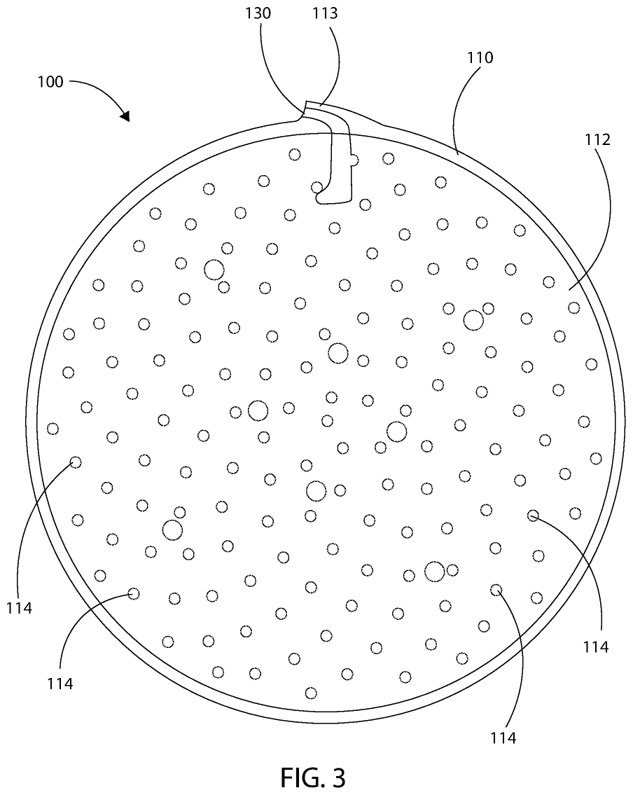

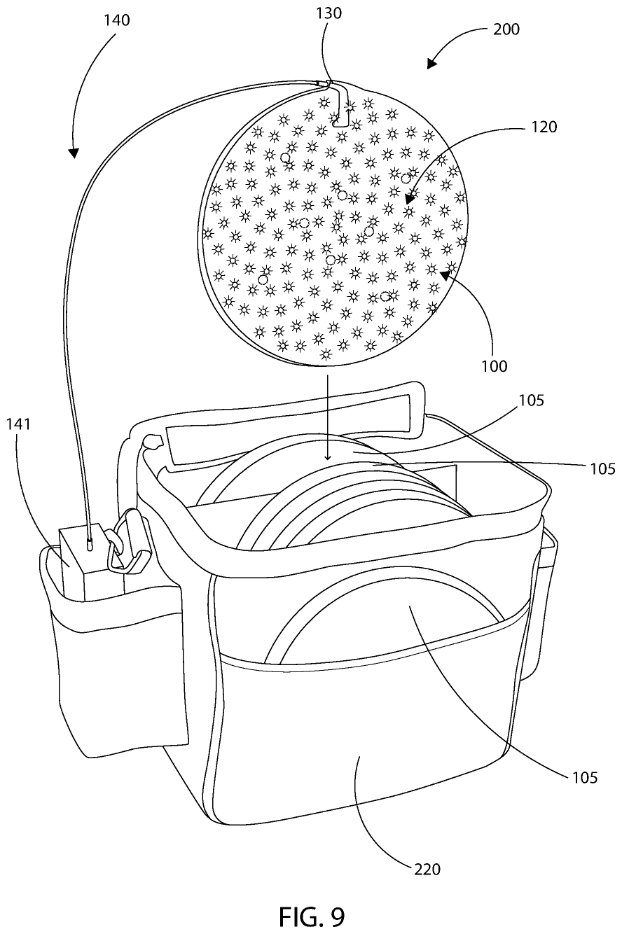

In some embodiments, the body 110 may be substantially transparent, enabling the plurality of light emitting diodes 121 to be seen from both the first side 111 and the second side 112 of the body 110. Additionally, or instead of this, as shown in FIG. 3 particularly, the first side 111 and the second side 112 of the body 112 may include a plurality of light apertures 114. The plurality of light apertures 114 may each be configured to receive, or overlay, one of the plurality of light emitting diodes 121, enabling the light emitted from the plurality of light emitting diodes 121 to be visible and emitted from both sides 111, 112 of the body 110 (the plurality of light emitting diodes 121 are illustrated emitting light in FIG. 9).

The power supply port 130 may be disposed within the body 110 and configured to connect the light source 120 with the external power supply 140, again as shown in FIG. 1. As above, the printed circuit board 122 (FIG. 2) may be electrically connected to the power supply port 130, and thus, may supply the light source 120 with power once connected with the external power supply 140. As shown in FIG. 3, the body 110 may include a protruding lip 113 located at a periphery of the body 110. In this embodiment, the power supply port 130 may be recessed into the protruding lip 113. This may position a plug 142 of the external power supply 140 (FIG. 1) at an angle when attached to the power supply port 130, so as to prevent breakage of the plug 142. In some embodiments, the power supply port 130 may include a barrel connector port. However, it should be appreciated that the power supply port 130 is not limited to being a barrel connector port. For example, the power supply port 130 may include (but is not limited to) a Universal Serial Bus (USB) port, a micro USB port, a USB-C port, etc.

As shown in FIGS. 5-6, due to the light source 120 being visible from both the first side 111 and the second side 112 of the body 110, the light source 120 may be able to charge at least two photoluminescent objects simultaneously. Particularly, as shown in FIGS. 5-6, the device 100 may be placed between the two photoluminescent objects to enable charging of the two photoluminescent objects simultaneously. In some examples, the light emitted by the light source 120 may be powerful enough for photoluminescent objects located behind each of the two photoluminescent objects to absorb the light energy also.

Further, in some embodiments, the light source 120 may be configured for selective dimming and/or intensification of the light emitted therefrom. Particularly, the light source 120, or more specifically, the plurality of LED's 121, may be selectively dimmed or intensified in various patterns so as to create various patterns, images, words, etc. on the discs. For example, the plurality of LED's 121 may illuminate in such a way as to form a star shape, and that star shape may then be transferred to the photoluminescent objects when the photoluminescent objects absorbs the light energy therefrom. It should however be appreciated that the device 100 may not be limited for use in charging objects. For example, the device 100 may be used simply for illumination purposes.

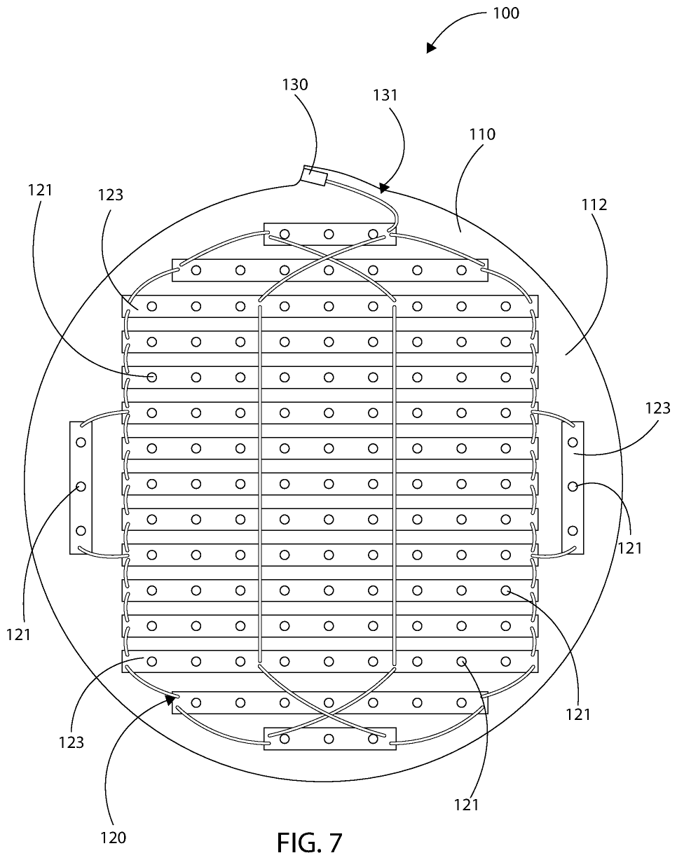

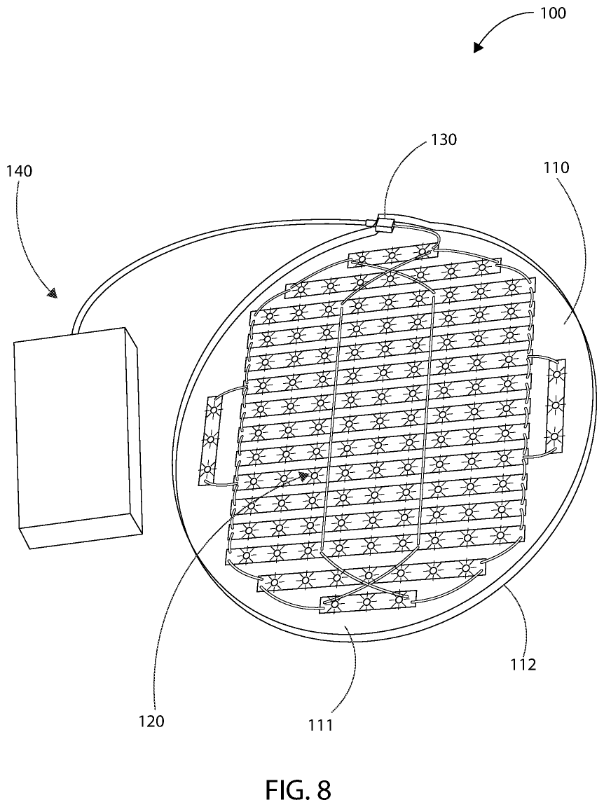

Referring specifically to FIGS. 7-8, there is shown the device 100 according to another embodiment. As shown, in this embodiment, the light source 120 may include a plurality of LED strips 123. The plurality of LED strips 123 may include a plurality of light emitting diodes 121 at either side thereof, enabling the light to be seen from both sides 111, 112 of the body 110. Further, as shown, in this embodiment, the device 110 may include an electric circuit 131 connecting the plurality of light emitting diodes 121 to the power supply port 130, and thereby connecting the plurality of light emitting diodes 121 to the external power supply 140.

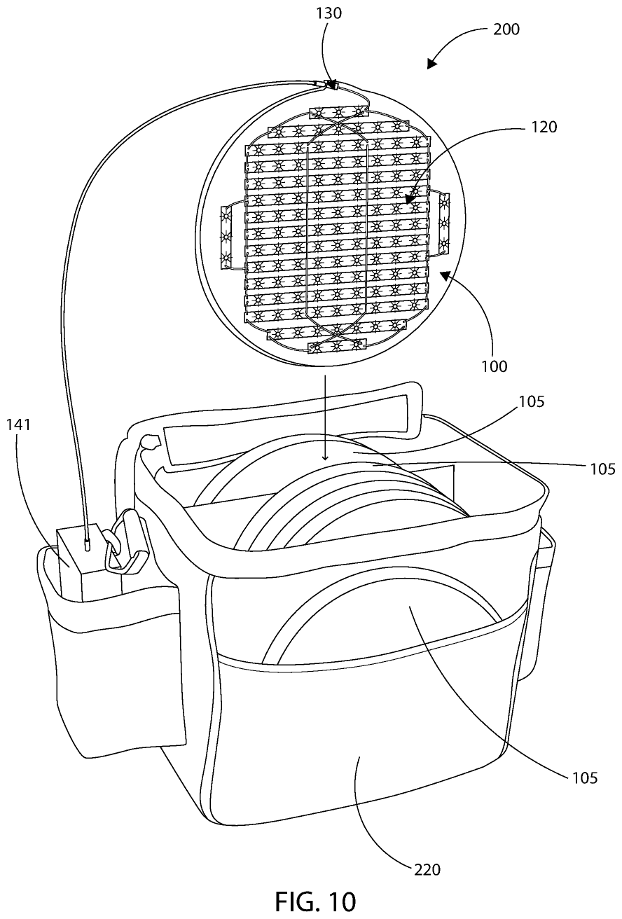

Referring more specifically to FIGS. 9-10, there is shown a photoluminescent flying disc system 200. The photoluminescent flying disc system 200, may include the device 100 as discussed above and illustrated in these figures (both embodiments discussed and shown here). Further, the photoluminescent flying disc system 200 may include a plurality of photoluminescent flying discs 105, and in some embodiments, a receptacle 220. The photoluminescent flying discs 105, as discussed above, may be made of a material configured to be charged by the light source 120 (i.e., containing phosphors). The light emitting diodes 121 in FIGS. 9-10 are shown to be emitting the light to charge the photoluminescent flying discs 105.

As shown in FIGS. 9-10, the receptacle 220 may be configured to store the plurality of photoluminescent flying discs 105 and the device 100 for charging the plurality of luminescent flying discs 105. Further, in some embodiments, the receptacle 220 may also store the portable battery 141. As above, the device 100 may charge at least two photoluminescent flying discs 105 simultaneously; and more particularly, when the device 100 is placed in between the two photoluminescent objects. As such, the receptacle 220 may store the device 100 between the two photoluminescent objects so that the photoluminescent objects are able to be charged during storage and/or transportation thereof.

In use of the device 100, a user may simply connect the external power supply 140 (FIG. 1) with the power supply port 130 of the device 100, by inserting the plug 142 of the external power supply 140 into the power supply port 130. The user may then place the device 100 between two photoluminescent objects. In some embodiments, the user may place the device 100 between the two photoluminescent flying discs 105 that are held with the receptacle 220 (FIGS. 9-10).

It should be noted that certain steps are optional and may not be implemented in all cases. It should also be noted that the steps described above can be carried out in many different orders according to user preference. It should also be noted that, under appropriate circumstances, considering such issues as design preference, user preferences, marketing preferences, cost, structural requirements, available materials, technological advances, etc., other methods for charging photoluminescent objects are taught herein.

Those with ordinary skill in the art will now appreciate that upon reading this specification and by their understanding the art of photoluminescence and particularly phosphorescence as described herein, methods of charging of photoluminescent flying discs using a device including a light source, will be understood by those knowledgeable in such art.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A device for charging photoluminescent objects, the device comprising:
a body including a first side opposite a second side;
a light source disposed within the body and configured to emit a light able to be absorbed by phosphors integral to the photoluminescent objects, the light being emitted at both the first side and the second side of the body, enabling the light source to charge at least two photoluminescent objects simultaneously when the body is inserted therebetween; and
a power supply port disposed in the body and configured to connect the light source with an external power supply.

2. The device of claim 1, wherein the body includes a disc-like shape, and wherein the first side and the second side are generally flat.

3. The device of claim 1, wherein the light source is configured to emit ultraviolet light.

4. The device of claim 3, wherein the light source includes a plurality of light emitting diodes.

5. The device of claim 4, wherein the first side and the second side of the body include a plurality of light apertures, and wherein each of the plurality of light aperture are configured to receive one of the plurality of light emitting diodes.

6. The device of claim 5, wherein the plurality of light emitting diodes are mounted to a printed circuit board and wherein the printed circuit board is electrically connected to the power supply port.

7. The device of claim 6, wherein the printed circuit board includes the disc-like shape.

8. The device of claim 7, wherein the body includes a protruding lip, and wherein the power supply port is recessed therein.

9. A device for charging photoluminescent flying discs, the device comprising:
a body including a disc-like shape and a first generally flat side opposite a second generally flat side;
a light source disposed within the body and configured to emit a light able to be absorbed by phosphors integral to the photoluminescent flying discs, the light being emitted at both the first side and the second side of the body, enabling the light source to charge at least two photoluminescent flying discs simultaneously when the body is inserted therebetween;
an external power supply including a portable battery; and
a power supply port disposed in the body and configured to connect the light source with the external power supply.

10. The device of claim 9, wherein the light source is configured to emit ultraviolet light.

11. The device of claim 10, wherein the light source includes a plurality of light emitting diodes, wherein the first side and the second side of the body include a plurality of light apertures, and wherein each of the plurality of light aperture are configured to receive one of the plurality of light emitting diodes.

12. The device of claim 11, wherein the plurality of light emitting diodes are mounted to a printed circuit board, wherein the printed circuit board is electrically connected to the power supply port, and wherein the printed circuit board includes the disc-like shape.

13. The device of claim 12, wherein the body includes a protruding lip, and wherein the power supply port is recessed therein.

14. A photoluminescent flying disc system comprising:
a plurality of photoluminescent flying discs; and
a device for charging the plurality of luminescent flying discs, the device including:
a body including a disc-like shape and a first generally flat side opposite a second generally flat side;
a light source disposed within the body and configured to emit a light able to be absorbed by phosphors integral to the photoluminescent flying discs, the light being emitted at both the first side and the second side of the body, enabling the light source to charge at least two photoluminescent flying discs simultaneously when the body is inserted therebetween;
a power supply port disposed in the body and configured to connect the light source with an external power supply.

15. The photoluminescent flying disc system of claim 14, further comprising the external power supply, wherein the external power supply includes a portable battery.

16. The photoluminescent flying disc system of claim 14, further comprising a receptacle configured to store the plurality of photoluminescent flying discs and the device for charging the plurality of luminescent flying discs.

17. The photoluminescent flying disc system of claim 14, wherein the light source is configured to emit an ultraviolet light.

18. The photoluminescent flying disc system of claim 17, wherein the light source includes a plurality of light emitting diodes, wherein the first side and the second side of the body include a plurality of light apertures, and wherein each of the plurality of light aperture are configured to receive one of the plurality of light emitting diodes.

19. The photoluminescent flying disc system of claim 18, wherein the plurality of light emitting diodes are mounted to a printed circuit board, wherein the printed circuit board is electrically connected to the power supply port, and wherein the printed circuit board includes the disc-like shape.

20. The photoluminescent flying disc system of claim 19, wherein the body includes a protruding lip, and wherein the power supply port is recessed therein.
